(19) United States
(12) Patent Application Publication
(10) Pub. No.: US 2020/0213434 A1
(43) Pub. Date: Jul. 2, 2020

(54) Mobile Device Integration of a Portable Metal Detector

(71) Applicant: AIR MD CORP., South San Francisco, CA (US)

(72) Inventors: Oleksii Samkov, Kyiv (UA); Semen Protsenko, Kyiv (UA); Oleksandr Kravchenko, Kyiv (UA); Kostiantyn Tymonkin, Kyiv (UA); Vilen Blinkov, Miami Beach, FL (US)

(73) Assignee: AIR MD CORP., South San Francisco, CA (US)

(21) Appl. No.: 16/727,815

(22) Filed: Dec. 26, 2019

Related U.S. Application Data
(60) Provisional application No. 62/784,874, filed on Dec. 26, 2018.

(51) Int. Cl. H04M 1/04; G01V 3/15; H04W 4/80

(52) U.S. Cl. CPC H04M 1/04; H04W 4/80; G01V 3/15

(57) ABSTRACT

Embodiments of the present invention provide for a system and apparatus for mobile device integration of a portable metal detector. In an embodiment of the invention, a portable metal detector includes a shaft, a handle attached to shaft, a mobile device housing attached to the handle, and a search coil attached to a distal end of the shaft. The search coil includes a search coil configured to wirelessly transmit a signal detected by the search coil.

### CROSS-REFERENCE TO RELATED APPLICATIONS

This application claims the benefit of U.S. Provisional Application No. 62/784,874, filed Dec. 26, 2018, the entirety of which is incorporated herein by reference.

### BACKGROUND OF THE INVENTION

### Field of the Invention

The present invention relates to metal detectors and more particularly to portable metal detectors with mobile device integration.

### Description of the Related Art

Metal detectors allow for the detection of metal objects hidden in the ground and other environments, such as water. Portable metal detectors allow for hobbyists and professionals to search for metal objects, such as coins, weapons, pipes, cables, etc. In order to detect metal objects, metal detectors include a transmission coil to transmit an electromagnetic field signal and a receiving coil that receives the signal generated from the magnetic field of the metal object. Metal detectors also include a control unit mounted on the metal detector that sends the transmission signal to the transmission coil over a conductive connection and receives the signal received from the receiving coil over a conductive connection. The control unit then processes the signal and displays the results on the control unit of the metal detector or may send the results as a sound to the end user's headphones.

Therefore, the processing capabilities of portable metal detectors are limited to the hardware and software of the control unit of the metal detector. The control units of a metal detector cannot be easily updated or changed. Furthermore, the control units on metal detectors are oftentimes bulky in order to include a significant amount of hardware to process the analog signals of the receiving coil and transmission coil. In addition to the proprietary hardware of control units with displays that cannot be changed, the software on the control units are also proprietary and cannot be updated or changed. As such, control units and metal detectors cannot perform modern digital signal processing capabilities without significant cost to the end user in the form of proprietary hardware and software, added weight that reduces ease of use, and little to no customizability of the display and functions included in the control unit.

### BRIEF SUMMARY OF THE INVENTION

Embodiments of the present invention address deficiencies of the art in respect to metal detectors and provide a novel and non-obvious system and apparatus for mobile device integration of a portable metal detector. In an embodiment of the invention, a portable metal detector includes a shaft, a handle attached to shaft, a mobile device housing attached to the handle, and a search coil attached to a distal end of the shaft. The search coil is configured to wirelessly transmit a signal detected by the search coil.

In one aspect of the embodiment, the signal is wirelessly transmitted over Bluetooth. In one aspect of the embodiment, the signal is wirelessly transmitted over Wi-Fi. In one aspect of the embodiment, the signal is wirelessly transmitted over a cellular network. In another aspect of the embodiment, a mobile device is configured to receive the signal wirelessly transmitted by the search coil to process the signal for the detection of metallic objects. In another aspect of the embodiment, the signal is only processed on the mobile device.

In yet another aspect of the embodiment, the search coil is further configured to wirelessly receive a transmitted signal to control the search coil for the detection of metallic objects. In yet another aspect of the embodiment, a mobile device is configured to transmit the signal wirelessly received by the search coil to control the search coil for the detection of metallic objects.

In even yet another aspect of the embodiment, the search coil further comprises a search coil display screen and the search coil display screen displays a charge of a battery of the search coil. In even yet another aspect of the embodiment, the search coil further comprises a magnetic connector for recharging the battery of the search coil. In even yet another aspect of the embodiment, the search coil comprises a temperature sensor and the search coil display screen displays an ambient temperature. In even yet another aspect of the embodiment, the search coil further comprises a LED light on a bottom side of the search coil.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for mobile device integration of a portable metal detector.

FIG. 2 is a schematic illustration of a data processing system configured for mobile device integration of a portable metal detector.

FIG. 3 is a flow chart illustrating a process for mobile device integration of a portable metal detector.

FIG. 4 is a second schematic illustration of a data processing system configured for mobile device integration of a portable metal detector.

### DETAILED DESCRIPTION OF THE INVENTION

Embodiments of the invention provide for mobile device integration of a portable metal detector. In accordance with an embodiment of the invention, a portable metal detector includes a shaft, a handle attached to shaft, a mobile device housing attached to the handle, and a search coil attached to a distal end of the shaft. The search coil is configured to wirelessly transmit a signal detected by the search coil over Bluetooth to a mobile device housed in the mobile device housing. In this way, the mobile device is able to be used as the control block eliminating the need for a bulky and inefficient control block mounted and conductively connected on the metal detector. Thus, the portable metal detector remains inexpensive, lightweight and fully customizable by the end user and the applications of the mobile device that control the metal detector.

In addition to eliminating the limiting control block mounted on the metal detector, using a mobile device as the control block allows for additional functionality afforded to digital signal processing and the mobile devices ability to connect and continually update from remote servers and the cloud. The use of a mobile device allows for (1) predictive analysis algorithms based on the database of typical signals to provide indicators of what is below the ground; (2) machine learning used to teach the neural network recognizing various objects; (3) reprogrammable user interface and setting profiles can be changed instantly via the interface; (4) cloud based or device based storage and execution of software; (5) exfil of data collection to cloud; (6) GPS tagging of located items to include composition of item; (7) coil has graphical display only for coil status information, which preserves battery life and simplifies the amount of information presented to the user on the coil itself; (9) direct interface with social media and messaging in that pictures of the findings can be taken with the phone cam and uploaded to the social media or messages via the phone app; (10) coil has an internal rechargeable power supply that is separate from the mobile device; (11) small electronic device provides external computing via apps for software and reach back connectivity for data processing in the cloud; (12) mobile device easily changes the algorithms based on field testing of soil, water, etc to calibrate optimal detection of target materials; (12) Cellular, Bluetooth wireless connections for export of data and transmission of data for real time remote viewing; (13) in-field algorithm adjustments based on machine learning of the environment; and (14) the algorithms of the mobile device used with the metal detector may be optimized for the detection of live energy sources.

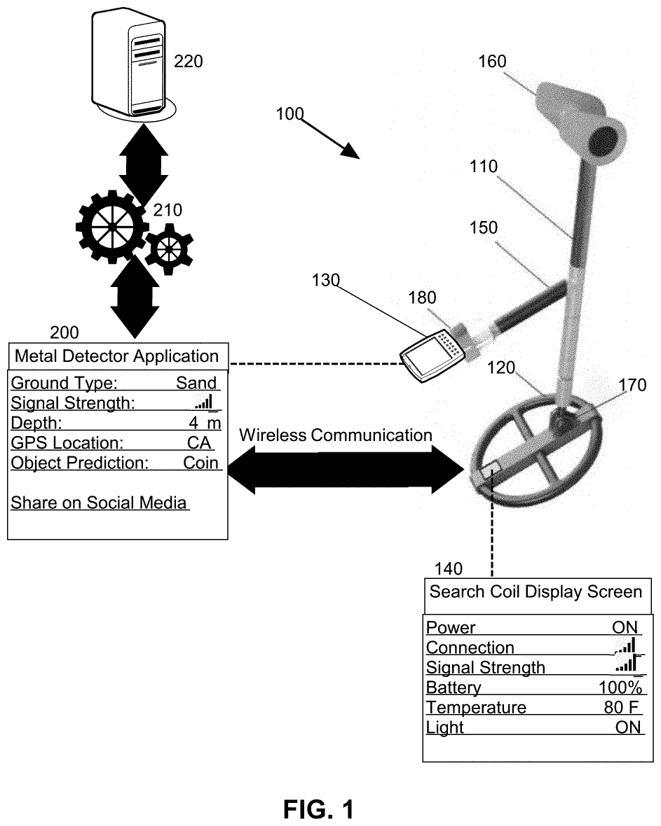

In further illustration, FIG. 1 is a pictorial illustration of a process for mobile device integration of a portable metal detector. As shown in FIG. 1, the portable metal detector includes a shaft 110 attached to a search coil 120. The search coil 120 may be protected by a search coil housing that may be waterproof. The search coil 120 is attached at the bottom end of the shaft by any mounting mechanism 170 and may allow the search coil to fold or rotate. The shaft is extendable in order to adjust for the user's height or for storage purposes. A folding arm rest 160 is attached at the opposite end of the shaft 110 from the search coil 120. The shaft or rod 110 also include a mobile device housing or mount 180 above the search coil 120 on the shaft 110. The mobile device housing 180 is able to hold the mobile device. As well, the metal detector also includes a handle 150 on the shaft 110. The mobile device housing 180 may be located on the handle 150 for ease of use.

The end user uses the portable metal detector 100 by inserting their arm on the folding arm rest 160 and gripping the handle 150, which may include a rubber grip for comfort. The mobile device 130, such as a smartphone or tablet, is inserted into the mobile device holder or housing 180, which may include a latch to secure the mobile device in place. In this way, the end user is able to hold the metal detector 100 with one hand on the handle 150 and operate the mobile device 130 with the other hand. The end user is able to store the portable metal detector 100 by folding the arm rest 160, folding the search coil 120 and/or housing and retracting the shaft to the shaft's smallest position 110.

The search coil 120 of the metal detector 100 includes an internal rechargeable battery, as well as magnetic reel connectors for charging the battery. The search coil 120 also includes a temperature sensor to determine the ambient temperature to optimize the search settings. Furthermore, the search coil 120 includes lights along the bottom portion of the search coil, where the bottom portion of the search coil is opposite the side of the search coil where the shaft 110 is connected to the search coil. The lights may be LED lights and allow the user to use the metal detector 100 in low light conditions. As well, the search coil includes a search coil display screen that may display the power and search coil settings, connection strength with the mobile device, the signal strength of the detected object, the battery level of the internal rechargeable battery of the search coil, the ambient temperature of the temperature sensor of the search coil, and an indicator of the light or lights on the bottom of the search coil. The search coil display or microdisplay 140 only displays relevant information of the search coil in order to optimize battery consumption, as the signal processing is only performed on the mobile device.

Importantly, the search coil 120 is connected to a mobile device 130 over a wireless connection. The wireless connection may be Bluetooth, Wi-Fi or a cellular network. The mobile device 130 through a metal detector application 200 is able to process the received signal from detected objects by the search coil 120. As well, the mobile device 130 through a metal detector application 200 is able to control the transmitted signal of the search coil. The mobile device application 200 is able to optimize the transmitted signal based on parameters supplied by the user. The search coil may include sensors to determine these parameters to transmit to the mobile device, including temperature and ground type, such as the type of soil, water content, etc.

In this way the mobile device 130 performs the digital signal processing (“DSP”) by wirelessly communicating with the search coil instead of a control block conductively connected to the search coil and mounted to the metal detector. Furthermore, as the DSP is performed in the mobile device 130 instead of a hardwired control block, the parameters are able to be changed and optimized by remotely updating firmware. The mobile device application may communicate with metal detector optimization engine 210 that stores previously detected information in the cloud or a remote server 220. Alternatively, this previously detected information may be stored within the mobile device itself, so that calling out to the cloud or remote server 220 is unnecessary. Furthermore, by moving the control block from the search coil to the mobile device, the interface of the mobile device is able to be customized and new functions through software updates are able to be added to the mobile device, as opposed to the permanent interface on the standard control block. The signal from the search coil 120 is transmitted to the mobile device 130 through Wi-Fi, cellular networks or Bluetooth, which allows for a stable signal of sufficient quality fast enough to maintain level of sensitivity and responsiveness comparable to wired or RF devices.

The metal detector application 200 is able to optimize the algorithm for the search coil and algorithm for the detections and predictive analysis of the received signal. The metal detector application 200 may include the input parameters or parameters received by sensors of the search coil, such as ground type and water content. The metal detector application 200 may include the signal strength of the detected object and display the signal strength. The metal detector application 200 may include algorithms to determine the depth of the object and display the predicted depth. The metal detector application 200 may use algorithms to determine the type of object and display the predicted type of object. The metal detector application 200 may use GPS of the mobile device to determine the location of the found objects and display the location of the end user or found objects. The end user may then share the findings on social media, e-mail or messaging through the metal detector application 200. Furthermore, the metal detector application 200 may store data received from the search coil locally on the mobile device 130 or in the cloud or remote server 220. The mobile device application and associated predictive analysis and search coil optimization patterns may be optimized through machine learning algorithms based on the data stored on the mobile device or in the remote server 220.

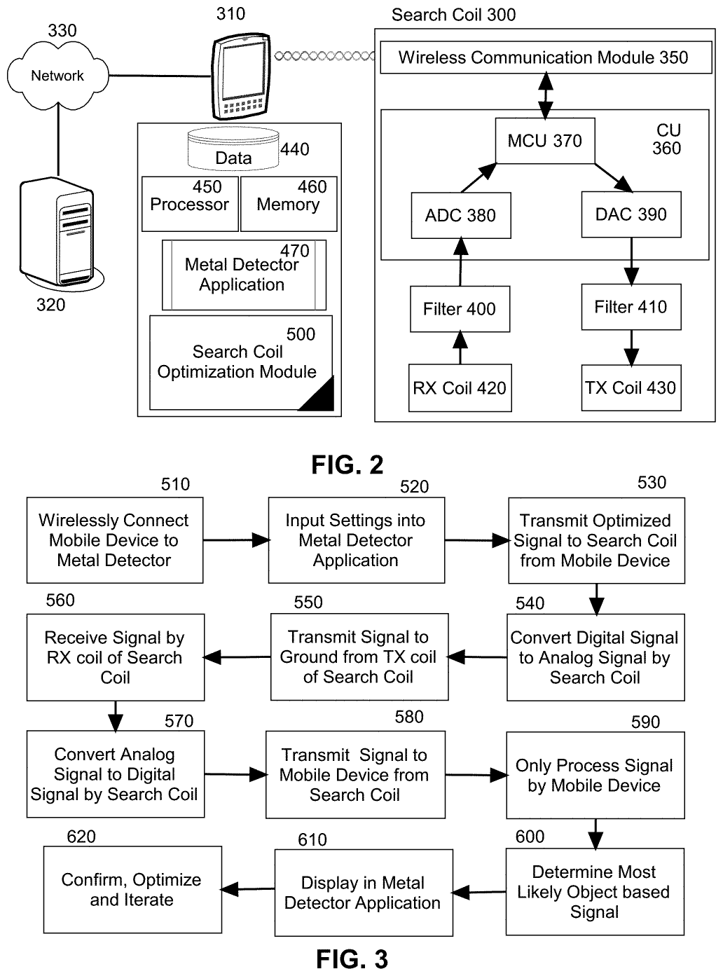

The process shown in FIG. 1 may be implemented in a computer data processing system. In further illustration, FIG. 2 schematically shows a data processing system configured for mobile device integration of a portable metal detector. The system includes a mobile device includes at least one processor 280 and memory 270 and fixed storage 260 disposed within the system. The mobile device may communicate over a network 330 with a cloud or server 320. The mobile device includes a metal detector application 470 and search coil optimization module 500. The metal detector application 470 and search coil optimization module 500 of the metal detector application may be updated over the network 330 from the server 320.

As well, the system includes a metal detector search coil 300. The search coil includes controller unit 360 with a microcontroller 370 that wireless communicates with the mobile device 310 through a wireless communication module 350 over a wireless connection, such as Bluetooth, Wi-Fi or cellular network. The microcontroller 370 receives an optimized transmission signal sent from the mobile device 310 through the wireless communication module. The microcontroller then converts the digital signal to an analog signal through digital-to-analog converter (DAC) 390. The analog signal is then filtered through filter 410 to remove any unwanted noise. The filtered analog signal is then sent to the transmission (TX) coil of the search coil 300. The signal from a detected object is received by the receiving (RX) coil 420. The analog signal is then filtered by filter 400 to remove any unwanted noise. The filtered analog signal is then converted to a digital signal by analog-to-digital converter (ADC) 380 and the digital samples are pre-processed and resulting signal is sent by microcontroller 370 to the mobile device through the wireless communications module 350.

Additionally, the microcontroller 370 of controller unit 360 runs power management of the search coil and the search coil display screen. As well, the microcontroller 370 is connected to the LED lights on the bottom of the search coil to operate the LED lights on the bottom of the search coil. Even further, the microcontroller 370 is connected to various sensors on the search coil 300 to include various parameters, such as ambient temperature and ground type on the search coil display or to communicate those parameters to the mobile device 310.

The metal detector application 470 and search coil optimizations module 500 includes program code that when executing in the memory of the mobile device 310 and server 320 is enabled to optimize the algorithm for the search coil and algorithm for the detection and predictive analysis of the received signal. The program code may include the input parameters or parameters received by sensors of the search coil, such as ground type and water content. The program code is further enabled to include the signal strength of the detected object. The program code may enable the use of algorithms to determine the depth of the object. The program code may enable the use of algorithms to determine the type of object. The program code may enable the use of the GPS of the mobile device to determine the location of the found objects. Furthermore, the program code may enable the storing of data received from the search coil locally on the mobile device 130 or in the cloud or remote server 220. The program code may include machine learning algorithms to optimize the predictive analysis and search coil optimization algorithms based on the data stored on the mobile device or in the remote server 220.

Additional detail on the hardware and software of the mobile device and coil are shown in in FIG. 4. Turning first to the software in the mobile device (shown in the top left quadrant of FIG. 4), the system includes an operating system and application software or libraries. The operating system provides a graphical user interface framework for providing display capabilities, an audio framework for providing audio capabilities, and a Bluetooth framework for Bluetooth communication.

The mobile device receives Bluetooth (or other wireless) packets from the coil. These packets include signal data from the coil's board. The mobile device then filters further received signal using digital signal processing algorithms. The mobile device analyzes the resulting signal and “detects” the target. Through this process, the mobile device decides when to display information (graphically and/or through audio signals) to the user. For example, the mobile device may display the type of object detected (i.e. a coin) and the depth at which the object has been detected.

Turning to the bottom left quadrant of FIG. 4, the hardware features of the mobile device are shown. These components include components Bluetooth (or other wireless) components for wireless communication, as well as components for performing display and audio output.

Turning the bottom right quadrant of FIG. 4, the hardware components of the coil are depicted. These components include a Micro Controller Unit (MCU), for instance the STM32 family of controllers. The MCU includes a number of components, including a central processing unit, RAM memory, flash memory, and peripheral modules tied together with at least one bus. As shown in FIG. 4, in a preferred embodiment, this components will include a universal asynchronous receiver-transmitter (UART), digital to analog converter (DAC), analog to digital converter(s) (ADC1, ADC2, ADC3), and inter-integrated circuits (I2C).

The coil also includes a Bluetooth (or other wireless) module for communicating with the mobile device. The coil generates sine wave voltage via DAC to TX coil. The coil receives digitalized voltage samples from the RX coil via ADC. It calculates signal data (phase and magnitude) using a lock-in amplifier algorithm. It then transmits the calculated signal data to the mobile device via the Bluetooth module.

The coil receives control commands from the mobile device via Bluetooth, and performs them. The coil also does additional activities, including reading the battery charge, showing images on the OLED display, storing settings inside the MCU flash.

The coil detects objects by measuring RX coil phase and magnitude. A sine wave signal is sent from DAC to the TX coil, which generates a sine wave magnetic field. When a metal object is put inside of the TX coil field, the RX coil voltage will be changed. The logic then determines what metal object has been detected and how far away the detected object is.

Turning to the top right quadrant of FIG. 4, the software components of the coil are depicted. A network protocol defines the protocol for communication between the coil and the mobile device. The multi-frequency sine wave generator algorithm produces sine wave lookup table for required sine frequency (each particular coil has its own resonance frequency) within acceptable tolerance margins. The produced table is used to generate sine wave voltage using DAC. This sine wave voltage is filtered, amplified, and sent to the TX coil.

The lock-in amplifier implements an algorithm used to calculate RX coil's voltage magnitude and phase offset with respect to the RX coil. This performs even in a very noisy environment. The data from the RX coil, which has been digitalized by the ADC) is fed into the lock-in algorithm. The algorithm then calculates the magnitude/phase of that signal. Those parameters are then sent to the mobile device via Bluetooth (or other wireless communication).

The battery driver is used to calculate battery status, while the display driver is used for controlling the display on the coil.

In a preferred embodiment, mobile device works as follows. An app implementing the functionality disclosed herein is installed on a mobile device (such as a smart phone). A user powers on the coil and connects the coil via Bluetooth using the app. The app sends “handshake” packets to the coil to initiate communication between the app and the coil. The coil hardware starts sending coil signal data via Bluetooth to the mobile device. The app parses the packets received and extracts the coil data. The app then applies some filters on the received data, implementing DSP techniques. The resulting filtered signal is used in a “target detection” algorithm to determine when a useful signal has been detected. A useful signal, for example, is when some metal has been detected by the coil. The app can then indicate signal parameters to the user, for instance an estimation of the metal type and depth of the located metal object. The app may display different sounds for different types of detected objects.

The user interface allows the user to connect the coil, see when a target was found and what the properties of the target may be. The interface further allows the user to adjust some search settings (for example, metal discrimination parameters, sensitivity, etc.). The user may also perform ground balance procedures, change the volume or display characteristics, and power off the coil.

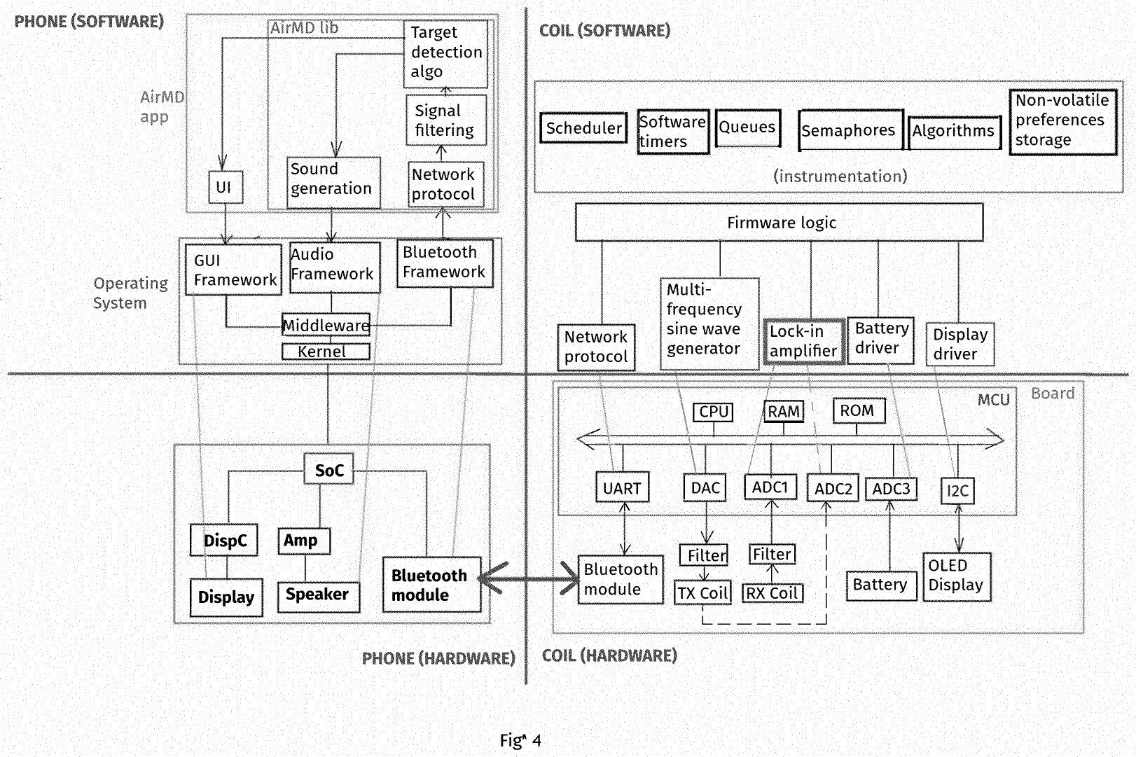

In even yet further illustration of the operation of the search coil optimization module 500 of metal detector application 470, FIG. 3 is a flow chart illustrating an exemplary process for mobile device integration of a portable metal detector. Beginning in block 510, the mobile device and metal detector are in wirelessly communication over Bluetooth. In block 520, the parameter settings are input in the metal detector application of the mobile device in order to optimize the search coil. Alternatively, the parameters settings are received from various sensors on the search coil through the microcontroller and wireless communication modules. In block 530, mobile device application determines the optimal signal for the TX coil of the search coil and sends the signal to the search coil from the mobile device. In block 540, the signal is then converted into an analog signal for use by the TX coil and the TX coils transmits the signal to the ground in block 550.

In block 560, the signal of a detected object is received by the RX coil and the signal is converted into a digital signal in block 570. In block 580, the digital received signal is transmitted to the mobile device and metal detector application of the mobile device over the Bluetooth connection. In block 590, the signal is only processed in the mobile device instead of on a control block mounted on the search coil. In block 600, the metal detector application of the mobile device determines the most likely object based on the received signal and parameters. In block 610, the type of object and relevant parameters and predictions, such as depth and type of object, are displayed in the metal detector application on a display of the mobile device. In block 620, the end user may then confirm the correct object in order to optimize the algorithm. The process is then iterated for additional objects.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A portable metal detector comprising:
a shaft;
a handle attached to shaft;
a mobile device housing attached to the handle; and,
a search coil attached to a distal end of the shaft, wherein the search coil is configured to wirelessly transmit a signal detected by the search coil.

2. The portable metal detector of claim 1, wherein the signal is wirelessly transmitted over Bluetooth.

3. The portable metal detector of claim 1, wherein the signal is wirelessly transmitted over Wi-Fi.

4. The portable metal detector of claim 1, wherein the signal is wirelessly transmitted over a cellular network.

5. The portable metal detector of claim 1, wherein a mobile device is configured to receive the signal wirelessly transmitted by the search coil to process the signal for the detection of metallic objects.

6. The portable metal detector of claim 5, wherein the signal is only processed on the mobile device.

7. The portable metal detector of claim 1, wherein the search coil is further configured to wirelessly receive a transmitted signal to control the search coil for the detection of metallic objects.

8. The portable metal detector of claim 7, wherein a mobile device is configured to transmit the signal wirelessly received by the search coil to control the search coil for the detection of metallic objects.

9. The portable metal detector of claim 1, wherein the search coil further comprises a search coil display screen and the search coil display screen displays a charge of a battery of the search coil.

10. The portable metal detector of claim 10, wherein the search coil further comprises a magnetic connector for recharging the battery of the search coil.

11. The portable metal detector of claim 9, wherein the search coil comprises a temperature sensor and the search coil display screen displays an ambient temperature.

12. The portable metal detector of claim 1, wherein the search coil further comprises a LED light on a bottom side of the search coil.
